(19) United States
(12) Patent Application Publication
(10) Pub. No.: US 2021/0233114 A1
(43) Pub. Date: Jul. 29, 2021

(54) System and Method for Enhancing Communication among Road Users

(71) Applicant: Chung Leung LAU, Hong Kong (CN)

(72) Inventor: Chung Leung LAU, Hong Kong (CN)

(21) Appl. No.: 16/630,859

(22) PCT Filed: May 24, 2019
(86) PCT No.: PCT/CN2019/088307

§ 371 Date: Jan. 14, 2020

Related U.S. Application Data
(60) Provisional application No. 62/696,819, filed on Jul. 11, 2018.

(51) Int. Cl. G06Q 30/02; G09F 21/04

(52) U.S. Cl. CPC G06Q 30/0266; G09F 21/04; G06Q 30/0267; G06Q 30/0273

(57) ABSTRACT

A system for broadcasting information to public by moving vehicles includes a server, a plurality of electronic devices, and a plurality of display panels. The server stores a plurality of user accounts and the information for broadcasting. Each electronic device is associated with at least one of the user accounts to communicate with the server. The display panels communicate with the electronic devices and are configured for attaching onto a vehicle. Information to be broadcasted can be selected in each user account on an electronic device associated with one of the display panels to display the information to the public.

### FIELD OF TECHNOLOGY

The present invention relates to a communication system, and more particularly to a communication system for road users.

### BACKGROUND

Vehicles are playing an important role in the daily life for people. At present, the vehicles are employed not only as tools for transportation, but can sometimes be used as advertising tools.

### SUMMARY

One example embodiment provides a billboard for attaching on a vehicle to broadcast information to public while the vehicle is traveling. The billboard includes a transceiver that communicates with a server via an electronic device; a display panel that is controlled by the electronic device to show the information; a sensor that senses a motion of the billboard and sends a motion signal indicating the motion to the server from the transceiver; and a monitoring device that sends a monitoring signal indicating the information displayed to the server from the transceiver. The electronic device is associated with the billboard by a user account stored in the server. The server analyses whether the information is displayed on the display panel when the vehicle is moving based on the motion signal and the monitoring signal.

Another example embodiment is a system for broadcasting information to public by moving vehicles. The system includes a server, a plurality of electronic devices and a plurality of display panels. The server stores a plurality of user accounts and the information for broadcasting. Each electronic device is associated with at least one of the user accounts to communicate with the server. The plurality of display panels communicate with the electronic devices, each display panel is configured for attaching onto a vehicle and is associated with at least one of the electronic devices. The information to be broadcasted can be selected in each user account on an electronic device associated with one of the display panels to display the information to the public. The same information can be broadcasted by more than one display panels on more than one vehicles.

Another example embodiment is a method for advertising an advertisement by a billboard attached on a vehicle. The method includes generating the advertisement and an advertisement bid by a server; generating a user account assigned to an electronic device by the server; and communicating with the electronic device by the server to send the advertisement to the billboard for broadcasting. The advertisement bid is associated with the advertisement.

One example embodiment is a system for recommending a social connection between vehicles. The system includes a server and an electronic device. The server stores a plurality of user accounts, collects locations of the vehicles associated with the user accounts, and calculates appearance frequencies of the vehicles within a predetermined distance of one of the vehicles during a pre-determined period. The electronic device is associated with a user account of the one of the vehicles and connects with the server to acquire the appearance frequencies and recommends the social connection based on the appearance frequencies.

Other example embodiments are discussed herein.

### BRIEF DESCRIPTION OF THE DRAWINGS

FIG. 1 illustrates a broadcasting system in accordance with an example embodiment.

FIG. 2 illustrates a billboard that is attached on a vehicle in accordance with an example embodiment.

FIG. 3 illustrates a method for advertising an advertisement by a billboard attached on a vehicle in accordance with an example embodiment.

FIG. 4 illustrates a method for broadcasting information to the public by a motor car traveling on the road in accordance with an example embodiment.

FIG. 5A illustrates a scenario when the cars cutting across lane in accordance with the example embodiment in FIG. 4.

FIG. 5B illustrates a scenario when the cars cutting across lane in accordance with the example embodiment in FIG. 4.

FIG. 6 illustrates a system for recommending a social connection between vehicles in accordance with an example embodiment.

FIG. 7 illustrates an advertising process by a billboard attached on a car in accordance with an example embodiment.

FIG. 8 illustrates a method for broadcasting information to the public by a moving car in accordance with an example embodiment.

### DETAILED DESCRIPTION

Example embodiments relate to methods and systems that enhance communication among road users.

With the development of the technology, vehicles can provide functions other than transportation, such as entertainment and communication. However, the conventional mode of communication between the road users is limited due to physical separation between them. Also, the use of interphones and mobile phones cannot reach the strangers passing nearby. With different driving behaviors and driving etiquette throughout the world, misunderstanding may be resulted in some situations, especially when travelling in a foreign country.

Conventional or existing methods use vehicles for presenting an advertisement (ad) in a static format. For example, putting advertisements on the bodies of the vehicles. However, it is difficult to replace the advertisements. The physical restrictions seriously limit the advertisers' ad orders placement options and creativity on ad designs.

One or more example embodiments solve the above-stated technical problems or difficulties by providing a dynamic way of broadcasting information to the public on the road. The unexpected result is that example embodiments can act as both an advertising tool and a multi-way communication tool.

Example embodiments of the present invention turns an ordinary vehicle into a dynamic advertising medium, which provides a more efficient and flexible way for advertising. The advertisers and subscribers can use a ubiquitous, mobile and dynamic advertising channel. The ad options are no longer bounded by any regimes and can vary anytime subject to the budget and the market demand. The subscribers of the system can be registered in terms of geographical locations so that advertisers can easily customize market exposure and carry out effective advertising strategy.

Example embodiments bring income to car owners through an introduction of an advertising broadcasting service, which allows direct deals between advertisers and subscribers of the system so that immense economic benefits are created to each party. Example embodiments include a system that promotes human touch connection among drivers by inviting users of the system to develop a social network adopting on-line and off-line approach, instead of purely an online experience like other social media. The system can recommend a social connection between vehicles in proximity frequently on the road. Also, the system can remind the presence of an added connection in proximity and send notifications. As a result, the drivers can build connections with those who live or work nearby, who always travel on the same route, who share the same destination etc.

Example embodiments include simple system that creates a new driving culture and improves driving manners of drivers. A better driving discipline and driving etiquette can be promoted in a positive and a fun way.

Example embodiments offer a mobile broadcasting system on the road. Car owners can provide free information service to the public and demonstrate a good civic responsibility in society.

As used herein, “offline approach” refer to offline connection in the example embodiments such as the physical appearance and co-existence of the users in close distance; the alert indicating the drivers' existence in close distance; and the communication of reaction and emotion to the drivers through display panels.

As used herein, “public” refer to the drivers, passengers and other road users outside of the vehicles.

As used herein, a “vehicle” mean a transportation tool that transports people or cargo, includes but not limited to a car, a truck, a motorcycle, a bicycle and a cart, and is not limited to commercial or private use.

As used herein, an “electronic device” means an apparatus for information processing and system control, which is able to move in space and is not limited to handheld device. By way of example, it can be any mobile electronic device such as mobile phone or an electronic device installed in a car.

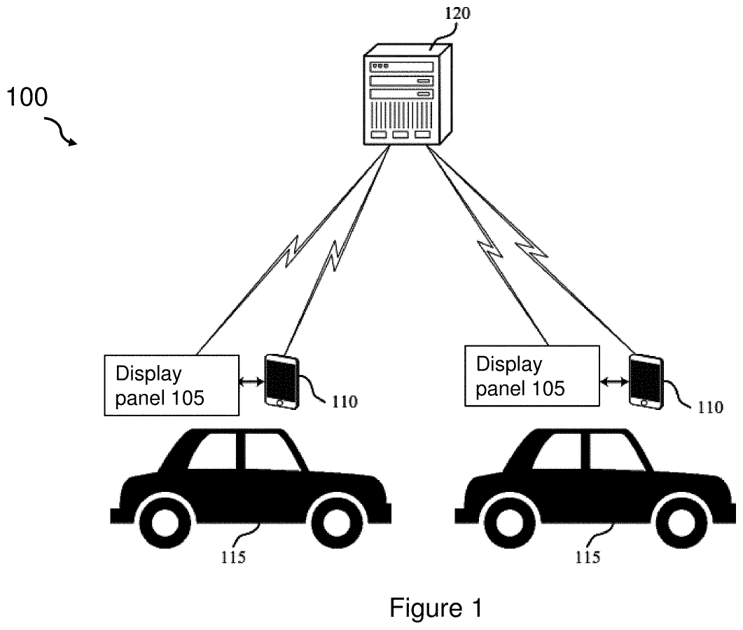

FIG. 1 shows a broadcasting system 100 in an example embodiment. The broadcasting system 100 includes display panels 105 attaching on cars 115, electronic devices 110 and a server 120. The server 120 can create and store a plurality of user accounts, and can store and provide the information for broadcasting. Users register and access their user account in the server 120 through a network connecting their electronic device 110 and the server 120. The users can select the information to be broadcasted by their electronic device 110, which connects and controls the display panels 105 of their cars 115 through the network. As a result, the same information can be broadcasted by more than one display panels 105 on more than one vehicles 115.

In another example embodiment, the server 120 stores a plurality of user accounts, collects locations of the cars 115 associated with the user accounts, and calculates appearance frequencies of the cars 115 within a pre-determined distance of one of the cars 115 during a pre-determined period. The users use their electronic devices 110 to connect with the server 120 to access their user accounts and acquire the appearance frequencies of vehicles 115 in proximity and recommendations on social connection. The recommendations can be based on the appearance frequencies of the vehicles 115 in proximity during certain period. Based on the recommendations, the users can connect with other users by their electronic devices 110. To build a social network in the server 120, the electronic devices 110 are linked together by linking their user accounts in the server 120. The server 120 can send a notification to the electronic devices 110 when the other vehicles 115 in the social network are within the pre-determined distance.

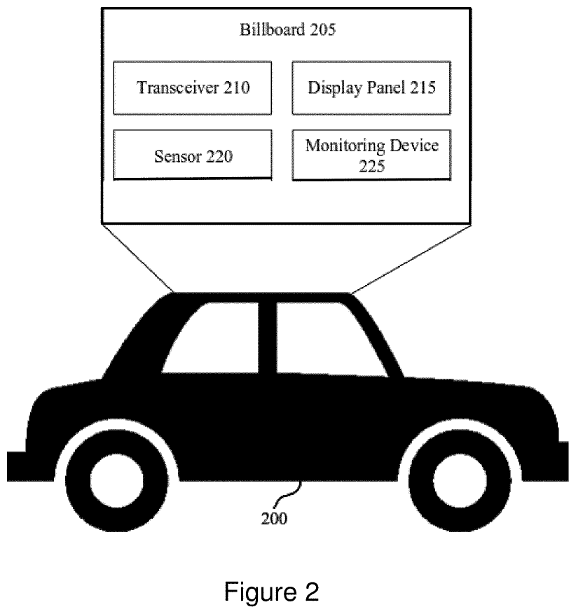

FIG. 2 shows a billboard 205 that is attached on a top of a vehicle 200 in one example embodiment. The billboard 205 includes a transceiver 210, a display panel 215, a sensor 220, and a monitoring device 225. A driver uses his electronic device (not shown in FIG. 2) to control the communication between the billboard 205 and a server. For example, the transceiver 210 of the billboard 205 can receive the information for broadcasting from the server. The transceiver 210 can send a motion signal indicating a motion of the billboard 205 to the server and a monitoring signal indicating the information displayed by the display panel 215 to the server. The electronic device is associated with the billboard 205 by a user account stored in a server. The driver can also use other electronic device to access his user account to control the display panel 215 to show the information. The sensor 220 senses a motion of the billboard 205 and generates the motion signal. The sensor 220 is selected from a group consisting of a speed sensor, a vibration sensor and a global positioning sensor. The monitoring device 225 generates a monitoring signal. The server analyses whether the information is displayed on the display panel 215 when the vehicle 200 is moving based on the motion signal and the monitoring signal. For example, the server calculates the period that the information broadcasted and the location of the billboard 205 during certain timing.

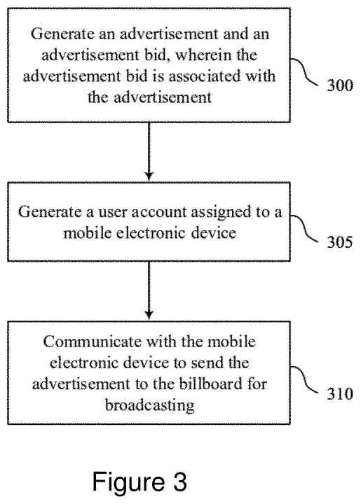

FIG. 3 shows a method for advertising an advertisement by a billboard attached on a vehicle in an example embodiment.

Block 300 shows generating the advertisement and an advertisement bid by a server. The advertisement bid is associated with the advertisement.

Block 305 shows generating a user account assigned to an electronic device by the server.

Block 310 shows communicating with the electronic device by the server to send the advertisement to the billboard for broadcasting.

In another example embodiment, the method illustrated in FIG. 3 further includes collecting a motion signal indicating a motion status of the billboard and a monitoring signal indicating the advertisement broadcasted on the billboard by the server, and determining whether the advertisement is broadcasted when the billboard is moving so that an advertisement fee, based on the actual duration and/or number of times the advertisement is broadcasted, can be credited to a transaction account.

In yet another example embodiment, the method illustrated in FIG. 3 further includes determining a duration that the advertisement is broadcasted by the server when the billboard is moving in order to credit an advertisement fee to a transaction account.

In one example embodiment, the method illustrated in FIG. 3 further includes adjusting the advertisement bid according to a number of orders for broadcasting the advertisement by the server.

In the other example embodiment, the method illustrated in FIG. 3 further includes determining a number of times that the advertisement is broadcasted when the billboard is moving in order to credit an advertisement fee to a transaction account.

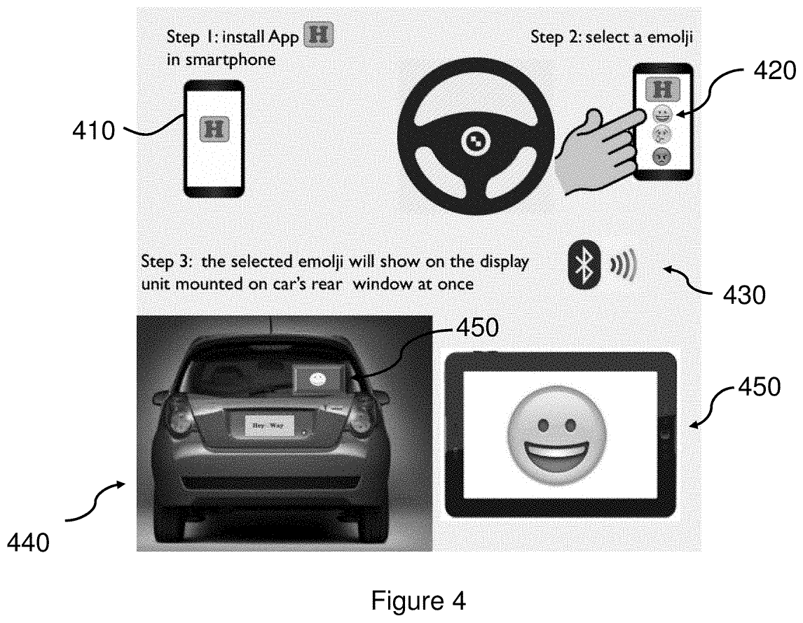

FIG. 4 shows a method for broadcasting information to the public by a motor car 440 traveling on the road in an example embodiment. The method includes installing an application in an electronic device, by way of example, installing a smartphone application on a smartphone 410; downloading images 420 from the smartphone application; selecting one of the images 420 on the smartphone application on a screen of the smartphone 410 and displaying the image 420 selected on a visual display unit (VDU) 450 which is attached to a rear window of the motor car 440 visible by other car drivers. The VDU 450 connects to the smartphone application via connection technology such as Bluetooth 430. The driver of the motor car 440 can update images 420 on the smartphone application from time to time. By way of example, the images 420 are emojis and are selected by sensing a touch on the screen of the smartphone 410 or by receiving a sound signal. By way of example, the images 420 denote “thank you”, “sorry”, “regret”, “Hi” etc for applying in different scenarios. By way of example, the emoji selected shows up in the VDU 450 instantly or with a delay for a pre-determined of time. By way of example, the images 420 can be created and updated by the driver on the smartphone application. By way of example, the driver can pre-set several options of images 420 on the screen before go driving. By way of example, videos can also be sent via Bluetooth 430 from the smartphone 410. By way of example, images 420 and videos can be sent to the VDU 450 via embedded data card in the VDU 450.

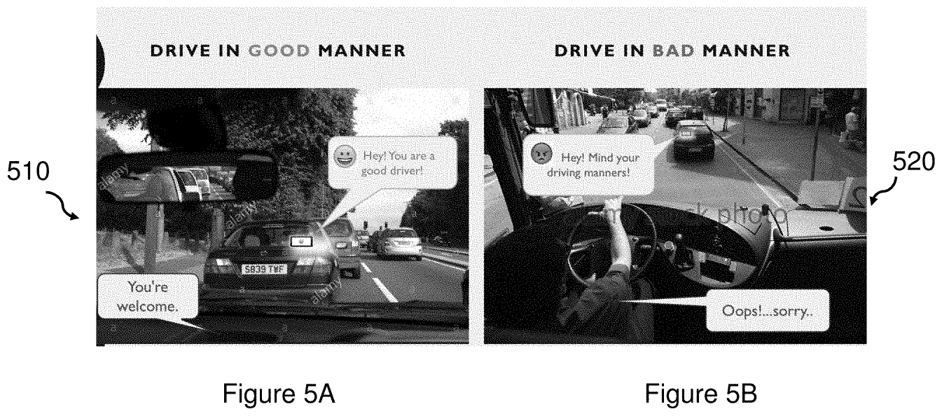

FIGS. 5A and 5B show scenarios 510 and 520 when the cars cutting across lane in the example embodiment of FIG. 4. For scenario 510, the driver displays an emoji that denotes “Hey! You are a good driver!” as a response to the other driver's friendly driving behavior on the VDU 450. For scenario 520, the driver displays another emoji that denotes “Hey! Mind your driving manners!” as a response to other driver's unfriendly driving behavior on the VDU 450. When the other drivers see the emoji, they realize how their driving manners are judged by others. In time, they will react to further improve their driving behavior.

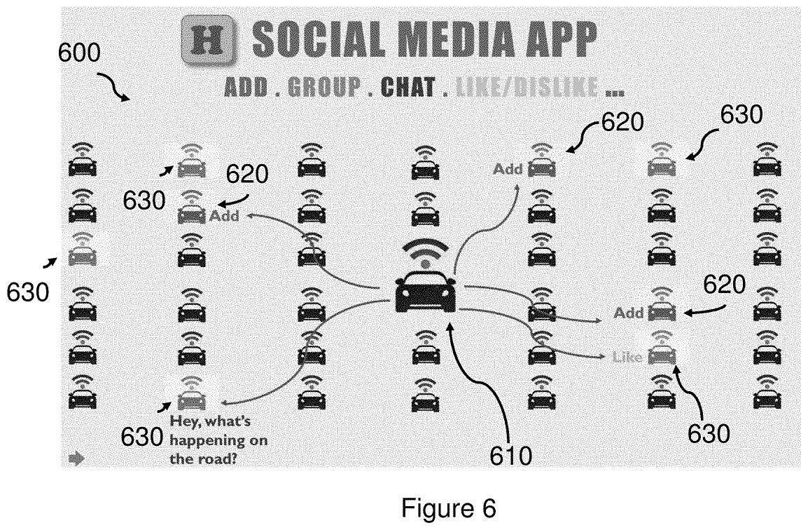

FIG. 6 shows a system 600 for recommending a social connection between vehicles in one example embodiment. The system 600 includes a server and a plurality of vehicles. A driver of a vehicle 610 downloads a software application on his electronic device and registers his identification (ID) by inputting personal information such as his car plate number to become a software application subscriber. The server creates and stores a plurality of user accounts that are associated with drivers' IDs. The subscribers can be located by Global Positioning System (GPS) when the subscribers are driving. The software application can scan and analyze a frequency of appearance of other subscribers' vehicles which are in proximity to the vehicle 610 over a period.

For example, the software application can scan the frequency of appearance of vehicles in 200 meters over the past weeks or months. The software application can ascertain frequently appearing vehicles from time to time and notify the driver of the vehicle 610 if he wants to send invitations to the other subscribers and add them as friends, as shown as vehicles 620 which belong to the other subscribers in FIG. 6. The driver can also invite and add their known friends who also are subscribers via other social network media such as Facebook and Twitter. When the added friends appear in proximity, the software application sends notifications to the driver of the vehicle 610 informing the driver of the presence of the added friends. The driver of the vehicle 610 can communicate with the added friends by the software application or by displaying an expression on a display unit on the vehicle 610 visible by the road users. The driver of the vehicle 610 can give a mark such as “like” or a “dislike” to other subscribers on the software application. The number of “like” and “dislike” can intermittently show up in the display units of the vehicles. In addition, the driver can show his own account information such as a number of social connections, cumulative “likes” and “dislikes”, achieved social status defined in the system (e.g. 1-5 stars hierarchy) or the software application etc. visible by others so as to encourage more connections and promote better driving behavior and sense of civic responsibility. The subscribers can form groups by connecting their user account in the server, as shown as the vehicles 630 which belong to a group of subscribers in FIG. 6. The connected subscribers can chat online through the software application on their electronic devices, as shown “Hey, what's happening on the road?” in FIG. 6.

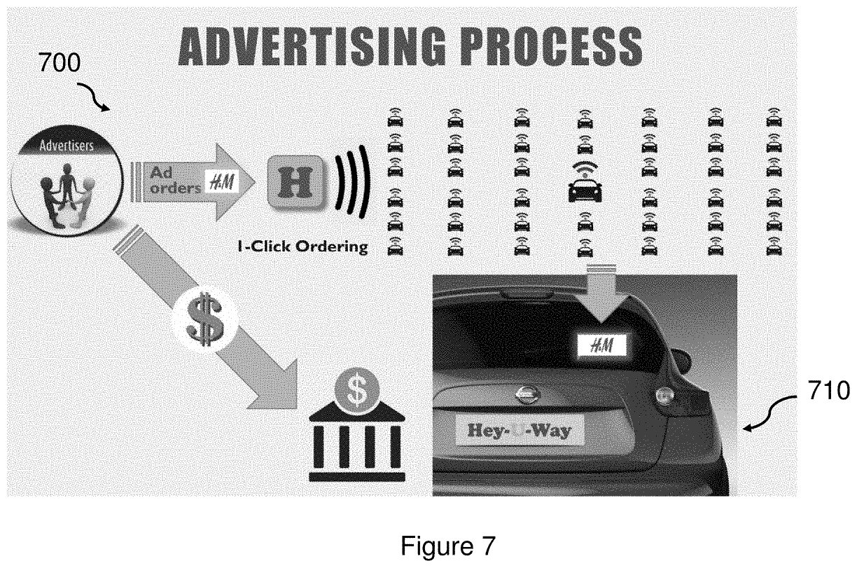

FIG. 7 shows an advertising process 700 by a billboard attached on a car 710 in one example embodiment. A user becomes a subscriber of an application by inputting his information on a mobile or a website, and his information will be stored in a server associated with a user account. Advertisers can place ad orders on an application at a certain fee and duration, e.g. price per spot/duration. The subscriber can preview all the ad orders promptly on the mobile or the website and choose to accept the ad orders on a first-come-first-served basis using a one-click ordering function. The one-click ordering function allows transaction to be completed in lightning speed, i.e. in one-click. The subscribers can select the ad orders based on their own preference: e.g. the ad fee, brand image, product quality, company reputation etc. Also, the subscribers can create his own portfolio of ad orders subject to a maximum quota, e.g. total advertising time is 6,000 minutes to loop for one month, and can choose their portfolio of ads to be broadcasted in a specified period. The advertisers can adjust the fee and volume anytime depending on a market response, i.e. they can raise fee to attract more subscribers to take orders, or stop the offerings once the intended ad volume has been fully absorbed by the market. The ad will automatically broadcast and loop subject to terms when the display unit is on during driving and is detected by GPS. Advertising fee will be paid by advertisers and credited directly to the subscribers' bank accounts. The operator of the software can also charge a certain fee. By way of example, the advertising fee can be done automatically by direct credit and debit of the respective stakeholders' bank accounts. Receipts of transactions can be viewable in the application or by email. The advertising process 700 can further include detecting the billboard that is not installed on the car 710 or the car 710 with the billboard is not in driving mode, in such case ad broadcasting obligations are not fulfilled and advertising fee will not be paid by the advertisers to the subscribers. Under this mechanism, the unit price and advertising volume is determined solely by free market force. The subscribers and the advertisers are engaged in a bidding process and the price, volume and various ad placement options will be reached by demand and supply.

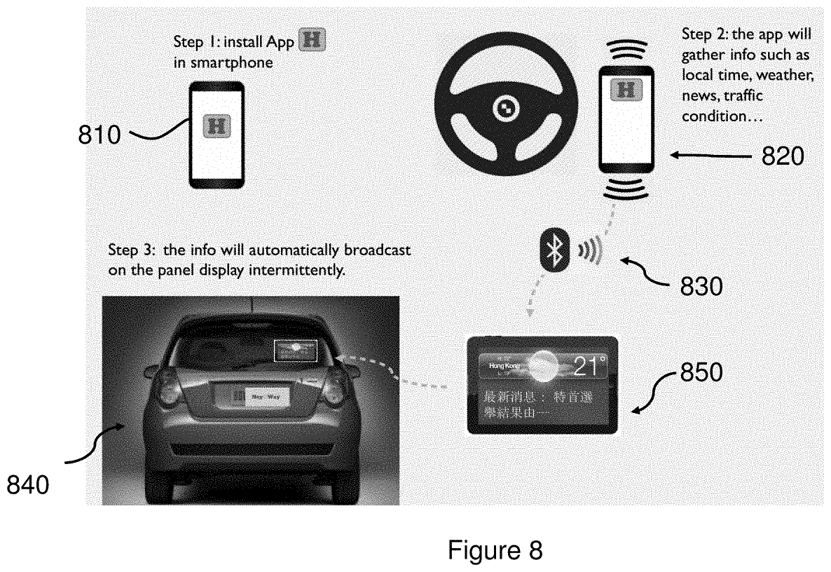

FIG. 8 shows a method for broadcasting information to the public by a moving car 840 in an example embodiment. It includes installing a smartphone application on a smartphone 810; gathering information by the smartphone application; and transmitting the information to a display panel 850 on the car 840 to broadcast the information intermittently to other road users when the display panel 850 is turned on. The information can be local and customized information such as local time, temperature, stock performance, weather, news, traffic condition, public urgent announcements etc. according to the location of the car 840. The information can be free information that is provided from local business partners and content providers, such as news organizations, social media and government departments.

Blocks and/or methods discussed herein can be executed and/or made by a user, a user agent (including machine learning agents and intelligent user agents), a software application, an electronic device, a computer, firmware, hardware, a process, a computer system, and/or an intelligent personal assistant. Furthermore, blocks and/or methods discussed herein can be executed automatically with or without instruction from a user.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

By way of example, the network in the example embodiments can include one or more of a wireless network for communicating one or more signals via Bluetooth, Wi-Fi, infrared (IR) or radio frequency (RF), such as internet, cellular network, a wireless voice network, etc.

By way of example, the information for broadcasting in the example embodiments includes but not limited to advertisements, news, weather reports, stock reports, public urgent announcements and traffic situation reports. A publicity of the same information broadcasted increases according to how many users select to display the information.

By way of example, the information for broadcasting in the example embodiments is streaming media. The information can be provided by streaming via the network connecting the display panel and the server. The information can also be provided by streaming via the network connecting the display panel and the electronic device.

By way of example, the information for displaying on the display panel in the example embodiments includes but not limited to ideograms and messages such that the user of his electronic device can express reactions and emotions to the public.

By way of example, the locations of the vehicles or the billboard or the display panel and/or the electronic device in the example embodiments are acquired by Global Positioning System (GPS) sensors at the vehicles.

By way of example, the display panel, the display unit and the VDU in the example embodiments are interchangeable and refer to any display for sending information to the public. The display panel can be attached at a top, a rear or a side of the vehicle, and can be a part of an exterior body of the vehicle. The display panel can be of any shape. The display panel can be attached or adhered on the vehicle by any means. The exterior body of the vehicle are parts visible to the outside of the vehicle, includes but not limited to the windows and the doors of the vehicle. Also, the display panel can be implemented on the vehicle such that images or videos can be visible from outside and invisible by the driver of the vehicle for safety reasons.

By way of example, the transaction account in the example embodiments is user account stored in the server or a credit account that is linked to the user account stored in the server.

In some examples, these operations can be performed by a processor executing a set of codes to control functional elements of an apparatus. Additionally or alternatively, the processes can be performed using special-purpose hardware. Generally, these operations can be performed according to the methods and processes described in accordance with aspects of the present disclosure. For example, the operations can be composed of various substeps, or may be performed in conjunction with other operations described herein.

The server in example embodiments provides one or more functions to requesting users linked by way of one or more of the various networks. In some cases, the server can include a single microprocessor board, which may include a microprocessor responsible for controlling all aspects of the server. In some cases, a server can use microprocessor and protocols to exchange data with other devices/users on one or more of the networks via an electronic transmission protocol. In some cases, the server is configured to send and receive files formatted for displaying web pages. Server can be a general purpose computing device, a personal computer, a laptop computer, a mainframe computer, a super computer, or any other suitable processing apparatus.

The transceiver in the example embodiments can communicate bi-directionally, via antennas, wired, or wireless links as described above. For example, the transceiver can represent a wireless transceiver and can communicate bi-directionally with another wireless transceiver. The transceiver can also include or be connected to a modem to modulate the packets and provide the modulated packets to for transmission, and to demodulate received packets. In some examples, transceiver can be tuned to operate at specified frequencies. For example, a modem can configure the transceiver to operate at a specified frequency and power level based on the communication protocol used by modem.

1. A billboard for attaching on a vehicle to broadcast information to public while the vehicle is traveling, comprising:
a transceiver that communicates with a server via an electronic device, the electronic device associated with the billboard by a user account stored in the server;
a display panel that is controlled by the electronic device to show the information;
a sensor that senses a motion of the billboard and sends a motion signal indicating the motion to the server from the transceiver; and
a monitoring device that sends a monitoring signal indicating the information displayed to the server from the transceiver,
wherein the server analyses whether the information is displayed on the display panel when the vehicle is moving based on the motion signal and the monitoring signal.

2. The billboard of claim 1, wherein the display panel is attached at a top, a rear or a side of the vehicle visible by the public.

3. The billboard of claim 1, wherein the display panel is a part of an exterior body of the vehicle.

4. The billboard of claim 1, wherein the information is streaming media.

5. The billboard of claim 1, wherein the sensor is selected from a group consisting of a speed sensor, a vibration sensor and a global positioning sensor.

6. A system for broadcasting information to public by moving vehicles, comprising:
a server, wherein the server stores a plurality of user accounts and the information for broadcasting;
a plurality of electronic devices, each electronic device is associated with at least one of the user accounts to communicate with the server; and
a plurality of display panels that communicate with the electronic devices,
wherein each display panel is configured for attaching onto a vehicle, each display panel is associated with at least one of the electronic devices,
wherein information to be broadcasted can be selected in each user account on an electronic device associated with one of the display panels to display the information to the public,
wherein the same information can be broadcasted by more than one display panels on more than one vehicles.

7. The system of claim 6, wherein the information includes advertisements, news, weather reports, stock reports, public urgent announcements and traffic situation reports so that a publicity of the same information broadcasted increases according to how many users select to display the information.

8. The system of claim 6, wherein the information is provided by streaming via a network connecting the display panel and the server.

9. The system of claim 6, wherein the information includes ideograms and messages such that a user of the electronic device can express reactions and emotions to the public.

10. A method for advertising an advertisement by a billboard attached on a vehicle, comprising:
generating, by a server, the advertisement and an advertisement bid, wherein the advertisement bid is associated with the advertisement;
generating, by the server, a user account assigned to an electronic device; and
communicating, by the server, with the electronic device to send the advertisement to the billboard for broadcasting.

11. The method of claim 10, further comprising:
collecting, by the server, a motion signal indicating a motion status of the billboard and a monitoring signal indicating the advertisement broadcasted on the billboard; and
determining, by the server, whether the advertisement is broadcasted when the billboard is moving so that an advertisement fee can be credited to a transaction account.

12. The method of claim 10, further comprising:
determining, by the server, a duration that the advertisement is broadcasted when the billboard is moving in order to credit an advertisement fee to a transaction account.

13. The method of claim 10, further comprising:
determining, by the server, a number of times that the advertisement is broadcasted when the billboard is moving in order to credit an advertisement fee to a transaction account.

14. The method of claim 11, wherein the transaction account is the user account or a credit account that is linked to the user account.

15. The method of claim 10, further comprising:
adjusting, by the server, the advertisement bid according to a number of orders for broadcasting the advertisement.

16. A system for recommending a social connection between vehicles, comprising:
a server, wherein the server stores a plurality of user accounts, collects locations of the vehicles associated with the user accounts, and calculates appearance frequencies of the vehicles within a pre-determined distance of one of the vehicles during a pre-determined period; and
an electronic device associated with a user account of the one of the vehicles, wherein the electronic device connects with the server to acquire the appearance frequencies of the vehicles and recommends the social connection based on the appearance frequencies.

17. The system of claim 16, further comprising:
a display that is attached on the vehicle for showing information of the user account to the public.

18. The system of claim 16, wherein the electronic device is linked with other electronic device by linking their user accounts in the server to build the social connection.

19. The system of claim 18, wherein the server sends a notification to the electronic device when the other vehicle of a linked user account is within the pre-determined distance.

20. The system of claim 16, wherein the locations of the vehicles are acquired by global positioning system (GPS) sensors at the vehicles.

21. The method of claim 12, wherein the transaction account is the user account or a credit account that is linked to the user account.

22. The method of claim 13, wherein the transaction account is the user account or a credit account that is linked to the user account.
